(19) United States
(12) Patent Application Publication
(10) Pub. No.: US 2003/0035359 A1
(43) Pub. Date: Feb. 20, 2003

(54) Optical pickup device

(75) Inventors: Ho-Seop Jeong, Sungnam-si (KR); Chon-Su Kyong, Seoul (KR); Seung-Man Oh, Suwon (KR)

Correspondence Address: MORGAN LEWIS & BOCKIUS LLP, 1111 PENNSYLVANIA AVENUE NW, WASHINGTON, DC, 20004, US

(73) Assignee: Samsung Electro-Mechanics Co., Ltd.

(21) Appl. No.: 09/994,693

(22) Filed: Nov. 28, 2001

(30) Foreign Application Priority Data
Aug. 17, 2001 (KR) 2001-49687

(51) Int. Cl. G11B 7/135

(52) U.S. Cl. 369/112.04; 369/120; 369/112.05; 369/112.15; 369/118; 369/112.29

(57) ABSTRACT

An optical pickup device having a lead frame package and a detecting unit is provided. The lead frame package includes a sub-mount, a light source mounted on the sub-mount and emitting a beam, a reflecting element disposed to direct the beam toward an optical medium, a transmission-type diffraction gating element dividing the beam into three beams, and a hologram optical element diffracting the beams reflected from the optical medium, the lead frame package having an opening defined by the hologram optical element, the bottom of the lead frame package, and side walls of the lead frame package. The detecting unit having a substrate and a photo diode mounted on the substrate is disposed within the opening of the lead frame package. After the detecting unit is adjusted with respect to the lead frame package to a position to accurately receive the reflected beams from the hologram optical element, the detecting unit is fixed to the lead frame package.

### BACKGROUND OF THE INVENTION

1. Field of the Invention

The present invention relates to an optical device employing hologram optical element, and more particularly to an optical pickup device having a lead frame package and a detecting unit, the lead frame package having a sub-mount and a laser diode while the detecting unit includes a substrate and a photo diode, the detecting unit fixed to the lead frame package after adjusted to a precise position relative to the lead frame package to receive beams which are emitted from the laser diode and reflected from an optical medium.

2. Description of the Prior Art

Optical pickup devices are used for detecting beams reflected from an optical medium, such as an optical disk, to read information stored in the optical medium and to write the information in the optical medium.

A conventional pickup device is provided with a laser diode (LD), a photo diode (PD), and a beam splitter (BS). As shown in FIG. 1, the pickup device includes a LD 11 emitting a laser beam, a diffraction grating element 12 splitting the laser beam into at least three beams, such as a zero order beam and positive and negative first order beams, a BS 13 reflecting the beams toward the optical medium, an objective lens 31 disposed between the BS and the optical disk to focus the beams upon a particular track of the optical medium, a concave lens 14 receiving reflected beams from the optical medium through objective lens 31 and providing astigmatic reflected beams, and a PD 15 detecting the astigmatic reflected beams. The beam emitted from LD 11 is incident onto the optical medium through diffraction grating element 12, BS 13, and objective lens 31. The beam reflected from the optical medium is detected by PD 15 through objective lens 31, BS 13, and concave lens 14.

This conventional optical pickup device, however, needs the great number of components including the BS and is disadvantageous due to the complicated structure and the process of assembling respective complicated components and due to the high cost for manufacturing of the conventional pickup device.

In an effort of reducing the size of the conventional pickup device, a pickup device using hologram had been introduced into an optical reading and writing apparatus. The hologram pickup device eliminating the BS and the concave lens and instead using the hologram reduces the number of complicated components. A beam reflected from the optical medium is diffracted by the hologram, and the PD detects the diffracted beam.

The conventional pickup device using the hologram is shown in FIG. 2. The hologram optical pickup device includes a LD emitting a laser beam, a diffraction grating element 22 dividing the beam into three beams, a hologram optical element (HOE) 26 receiving the three beams reflected from the optical medium and diffracting the reflected beams, a PD receiving the beams focused and directed by HOE 26. LD 21 and PD 25 are fixed on a single common substrate by means of die bonding. All of diffracting grating element 22, HOE 26, and LD 21 and PD 25 mounted on the single common substrate are integrated into a single package.

In this conventional hologram pickup device, the laser beam is divided into three beams by the diffraction grating element 22, and the three beams are converged on a surface of the optical medium by objective lens 31. The beams converged on the surface of the optical medium are reflected, and the reflected beams are detected by PD 25 after diffracted by HOE 26.

Since the beams diffracted by HOE 26 are detected by PD 25, the BS and the convex lens are eliminated. Therefore, the number of the optical components decreases. Moreover, the manufacturing cost may be lowered, and the structure of the device may become simple because LD 21, PD 25, diffraction grating element 22, and HOE are integrated into a package.

However, in order to accurately detect the beams diffracted by HOE 26, this hologram optical pickup device needs to arrange LD 21 and PD 25 at a relatively precise location on the single common substrate after LD 21 is mounted on the single common substrate. Because the tolerance between locations of LD 21 and PD 25 affects the hologram pickup device in terms of the performance of PD 25 detecting a beam emitted from the LD. The arrangement of LD 21 and PD 25 requires high cost equipment with high precision because LD 21 and PD 25 are mounted on the single common substrate.

The relative position between LD 21 and PD 25 should be precisely adjusted because the performance of the hologram optical pickup device depends upon the tolerance between the LD and the PD and because LD 21, PD 25, and HOE 26 are integrated on the single common substrate in the single package with the complicated manufacturing process. Moreover, the very precise die bonding is needed to mount LD 21 and PD 25 on the single common substrate. However, the equipment for the die bonding is too expensive to reduce the manufacturing cost for mounting LD 21 and PD 25 at the relative location in the single common substrate. Since the beam emitted from LD 21 and detected by PD 25 is not used for the manufacturing process of die bonding of LD 21 and PD 25, the relative position of PD 25 with respect to LD 21 can not be adjusted after LD 21 and PD is die bonded on the single common substrate of the hologram optical pickup device. Even if PD 25 is not precisely located on a position relative to LD 21, the location of PD 25 cannot be adjusted.

As described above, the conventional hologram pickup device is disadvantageous due to the manufacturing cost for adjusting the relative position of LD 21 and PD 22 and due to a complicated wafer process required to integrate LD 21 and PD 25 in the single common substrate.

### SUMMARY OF THE INVENTION

It is an object of the present invention to provide an improved hologram optical pickup device able to adjust a detecting unit having a photo diode to a precise position relative to a lead frame package having a laser diode by using and monitoring beams detected by the photo diode of the detecting unit.

It is another object to provide a hologram optical pickup device able to provide a separate substrates for a photo diode.

It is still another object to provide a hologram pickup device able to fix to a detecting unit having a photo diode to a lead frame package having a laser diode after the location of the detecting unit is adjusted with respect to the lead frame package by using and monitoring an output signal obtained from the photo diode during assembling the lead frame package and the detecting unit.

It is yet another object to provide a hologram optical pickup device able to assemble a first package having a laser diode and a separate package having a photo diode.

It is still yet another object to provide an optical pickup device able to reduce manufacturing cost of each of a first package having a laser diode and a second package having a photo diode.

It is also an object to provide an optical pickup device able to assemble a lead frame package having a laser diode and a detecting unit having a photo diode with a simple process without sacrificing precision and tolerance of the laser diode and the photo diode.

These and other objects of the present invention may be achieved by providing an improved hologram pickup device adjusting the location of a photo diode relative to a laser diode, the laser diode die-bonded on a sub-mount, the photo diode die-bonded on a separate substrate, the substrate fixed to the lead frame package by using and monitoring beams detected by the photo diode.

The pickup device includes a lead fame package and a detecting unit, the lead frame package having a sub-mount, light source, mounted on the sub-mount, emitting a beam, a reflecting element, such as a mirror, disposed to direct the beam toward an optical medium, a transmission-type diffraction gating element dividing the beam into three beams, such as a main beam and two sub beams, and a hologram optical element diffracting the beams reflected from the optical medium, the lead frame package having an opening, such as a perforation formed on the bottom of the lead frame package or between the bottom of the lead frame package and the walls of lead frame package and to form a receptacle shape, the detecting unit having the substrate and disposed within the opening of the lead frame package to be adjusted to a position to accurately receive the reflected beams from the hologram optical element. The detecting unit is fixed to the lead frame package after the location of the detecting unit is adjusted with respect to the lead frame package using the signal obtaining from the photo diode of the detecting unit. The opening is defined by the bottom of the lead frame package, the hologram optical element and the walls of the lead frame package.

In another embodiment, the hologram pickup device includes a lead frame package and a detecting unit having a separate substrate, the lead frame package have a light source emitting a beam, a diffraction grating element dividing the beam into the three beams directed onto the optical medium, and the hologram optical element receiving the beams reflected from the optical medium and diffracting the reflected beams, the lead frame package unit having an opening, the detecting unit disposed within the opening and fixed to the lead frame package after the position of the detecting unit is adjusted with respect to the lead frame package by using and monitoring the diffracted beams detected by the photo diode of the detecting unit.

A process of assembling the lead frame package having a laser diode and a detecting unit having a photo diode includes the steps of locating the detecting unit within the opening of the lead frame package, moving the detecting unit with respect to the lead frame package, monitoring a signal obtaining from the photo diode of detecting unit during movement of the detecting unit with respect to the lead frame package, and fixing the detecting unit to the lead frame package when the signal is in a predetermined range.

### BRIEF DESCRIPTION OF THE DRAWINGS

A more complete appreciation of the invention, and many of the attendant advantageous thereof, will be readily apparent as the same becomes better understood by reference to the following description when considered in conjunction with the accompanying drawings in which like reference symbols indicate the same or similar components, wherein:

FIG. 1 is a partial perspective view of a conventional pickup device;

FIG. 2 is a partial perspective view of a conventional hologram pickup device;

FIG. 3 is a perspective view of a hologram pickup device constructed according to the principles of the present invention;

FIG. 4 is a front view of the hologram pickup device of FIG. 3;

FIG. 5 is a plain view of the hologram pickup device of FIG. 3;

FIG. 6 is a perspective view of another embodiment of a hologram pickup device constructed according to the principles of the present invention;

FIG. 7 is a front view of the hologram pickup device of FIG. 6;

FIG. 8 is a perspective view of a third embodiment of a hologram pickup device constructed according to the principled of the present invention; and

FIG. 9 is a flow chart showing a process of fixing a detecting unit having a photo diode to a lead frame package having a laser diode.

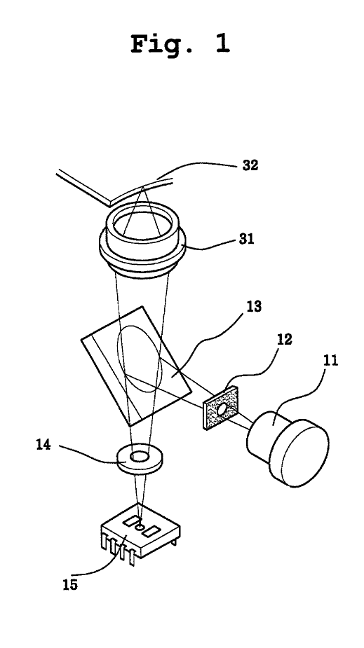

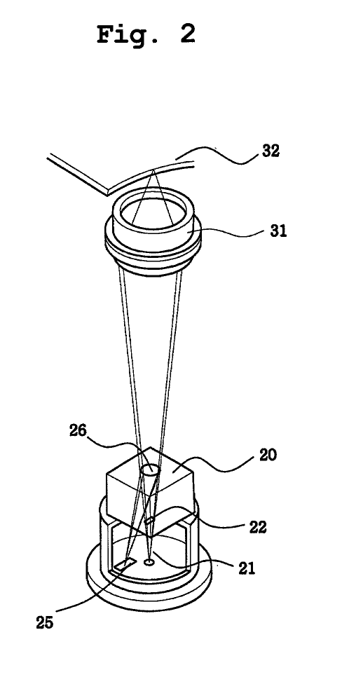

### DETAILED DESCRIPTION OF THE INVENTION

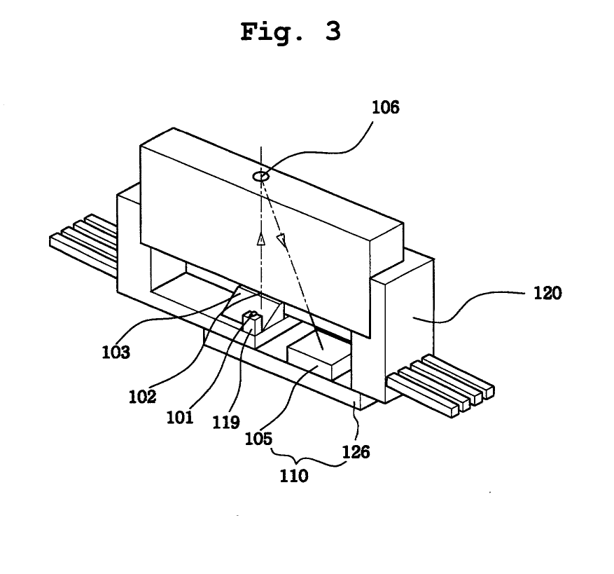

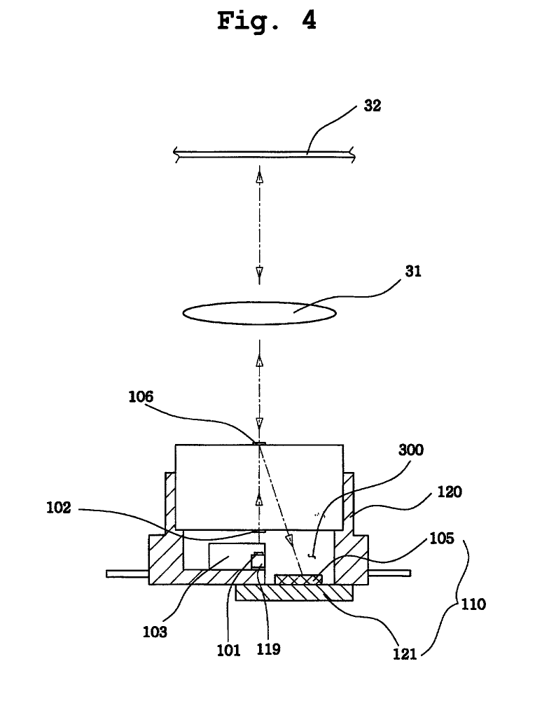

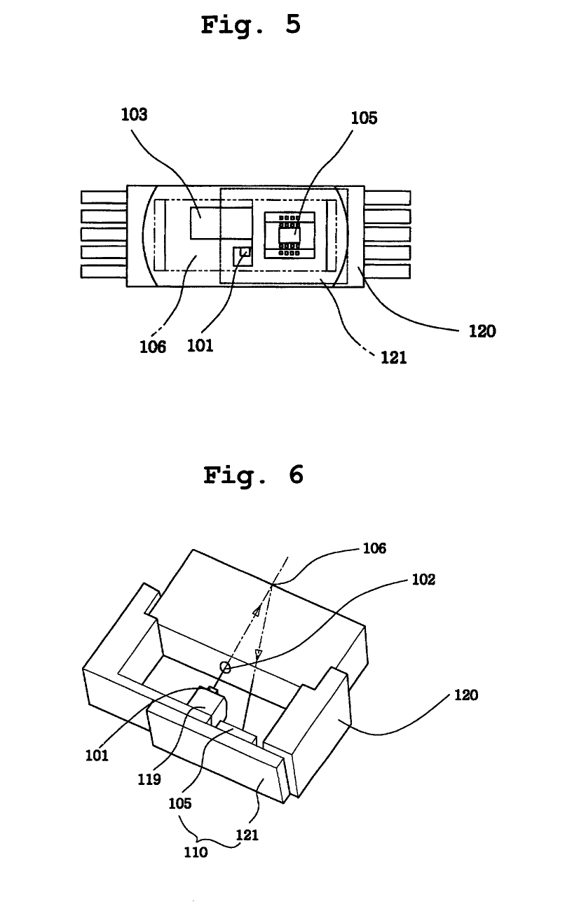

FIG. 3 shows a hologram pickup device constructed according to the principles of the present invention, and FIGS. 4 and 5 are front and plain views of the hologram pickup device, respectively.

The pickup device includes a sub-mount, a light source mounted on the sub-mount and emitting a laser beam, and a reflecting element reflecting the laser beam toward an optical reading and writing medium. The reflected beam from the reflecting element is divided into a main beam and two sub beams by a diffraction grating element. The beams transmitted through the diffraction grating element are converged on a surface of the optical medium by an objective lens. A hologram optical element (HOE) diffracts the beam reflected from the optical medium and converges the diffracted beam on a photo diode.

The sub-mount, the light source mounted on the sub-mount, the diffraction grating element, and the HOE are integrated into a lead frame package.

The lead frame package includes an opening disposed adjacent to the sub-mount of the lead frame package. The opening is defined by the HOE, the bottom of the lead frame package, and side walls of the lead frame package. The opening communicates with an outside of the lead frame package.

A detecting unit is formed separately and independently from the lead frame package and is disposed within the opening to move in a horizontal direction and a vertical direction and to rotate in a clockwise direction and a count-clockwise direction. The detecting unit moves in the direction parallel or perpendicular to the HOE or the bottom of the lead frame package and rotates about the diffracted beam diffracted from the HOE to accurately receive the beams before the detecting unit is fixed to the lead frame package. A chip-on-board (COB) photo diode package or a flip-chip package is used for the detecting unit.

The tolerance occurs when the laser beam emitting from the light source and reflected from the optical medium travels along optical paths through various optical components. The errors are generated because the beam is not impinged on the exact position of the photo diode of the detecting unit.

The detecting unit is adjusted by moves and rotates about the lead frame package. Therefore, the beam is precisely impinged on the accurate position of the detecting unit without the error caused by the tolerance.

The pickup device constructed according to the principles of the present invention is used for an optical reading and writing medium and apparatus, such as DVD-ROM, DVD-RAM, DVD-RW, CD-ROM, CD-RW, etc.

In FIGS. 3-5, a LD 101 is mounted on a sub-mount 119, and a mirror 103 direct a laser beam emitted from the LD 101 toward the optical medium 32. It is desirable to locate mirror 103 having an angle of 45 degree with respect to an axis of the laser beam emitted from LD 101 to direct the laser beam toward the optical medium 32.

A transmission-type diffraction grating element 102 is disposed above mirror 103 to divide the beam into at least three beams including a zero order beam and positive and negative first order beams. A hologram optical element (HOE) 106 is disposed above the diffraction grating element 102 to transmit the beams toward an optical medium 32. HOE 106 transmits the beams toward optical medium 32 without affecting the beams.

A lead frame package 120 includes an opening 300 disposed adjacent to sub-mount 119 of lead frame package 120. Opening 300 is defined by HOE 106, the bottom of lead frame package 120, and the side walls of lead frame package 120. Opening 300 communicates with HOE 106 and an outside of lead frame package 120.

As described above, sub-mount, LD 101 mounted on sub-mount 119, mirror 103, diffraction grating element 102, HOE 106 are installed in a single independent lead frame package 120.

The three beams transmitted through HOE 106 are converged on a surface of optical medium 32 by an objective lens 31. The three beams impinged on the optical medium are reflected and incident to HOE 106 through objective lens 31. HOE 106 diffracts the beams reflected from the optical medium 32. An axis of each diffracted beam has a predetermined angle with respect to the beam emitted from LD 101. The diffracted beams are directed to a detecting unit 110, such as the COB PD package having a photo diode integrated circuit (PDIC) 105 having a photo diode which is mounted on a substrate 121 separate from the lead frame package 120.

Detecting unit 110 is formed separately and independently from the lead frame package 120 and is disposed within opening 300 to move in a horizontal direction and a vertical direction and to rotate in a clockwise direction and a count-clockwise direction.

In order to adjust PDIC 105 at an accurate position where the diffracted beams are precisely impinged and detected, Detecting unit 110 moves in a direction W, N, E, S, U, or D or rotates in a direction A or B by using and monitoring signals obtained from the diffracted beams detected by the photo diode of PDIC 105 which is coupled to an external controller (not shown). Optical medium 32 is disposed above HOE 106 to provide the three beams as a reference beam which is used for detecting the accurate position of the photo diode of the PDIC 105. After adjusted to be located on the accurate position relative to HOE 106 of lead frame package 120, Detecting unit 110 is fixed to lead frame package 120 by means of a coupling element, such as soldering, welding, screw, etc.

In FIG. 6, since the laser beam emitted from LD 101 is directed to optical medium 32, mirror 103 of FIGS. 3˜5 is eliminated from lead frame package 120. LD 101 mounted on sub-mount 119, diffraction grating element 102 and hologram 106 are installed in single lead frame package 120. The beams reflected from the optical medium 32 are diffracted from HOE 106 are accurately detected by PDIC 105 when Detecting unit 110 moves with respect to HOE 106 or rotates about the diffracted beams by using and monitoring the diffracted beam detected by PDIC 105 during moving Detecting unit 110 within opening 300 formed in lead frame package 120. Detecting unit 110 is fixed and assembled to lead frame package 120 when the photo diode of PDIC 105 is disposed to accurately detect the diffracted beams.

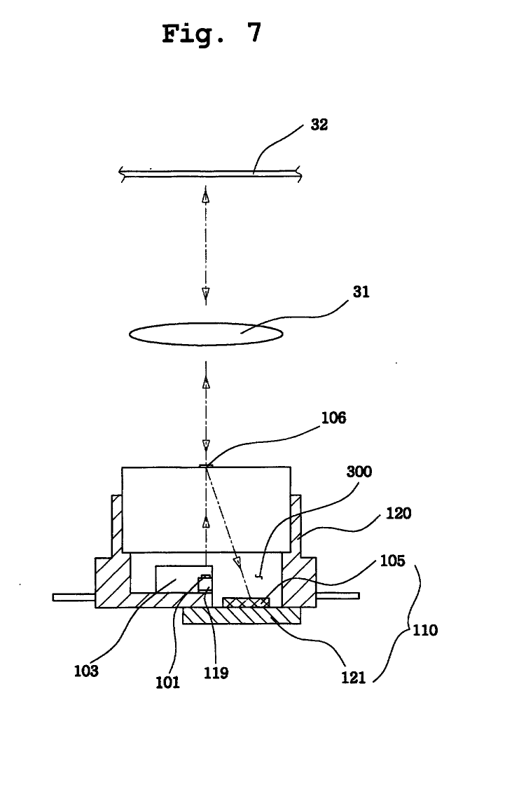

In FIG. 7, mirror 103 is installed in lead frame package 120 to reflect the beam emitted from LD 101 mounted on the sub-mount 119 toward optical medium 32. The laser beam is not divided into a plurality of beams because transmission-type diffraction grating element 102 is not included in lead frame package 120 as shown in FIG. 7. The beam emitted from LD 101 and reflected from mirror 103 is incident to optical medium 32 through HOE 106 and objective lens 31. LD 101 mounted on sub-mount 119, mirror 103, and HOE 106 are integrated in lead frame 120. The beam reflected from optical medium 32 and diffracted from HOE 106 is directed to PDIC 105 mounted on the substrate 121 of Detecting unit 110.

As described above in FIGS. 3-5, the signal obtained from the diffracted beam detected by PDIC 105 is monitored by the external controller coupled to PDIC 105 when Detecting unit 110 is moved and rotated with respect to optical medium 32 and HOE 106 of lead frame package 120. When the diffracted beam is accurately detected by PDIC, movement or rotation of Detecting unit 110 is stopped, and Detecting unit 110 is fixed to and assemble into lead frame package 120. Therefore, the optical pickup device obtains the accurate signal of the diffracted beam when the diffracted beam is precisely impinged on the photo diode of Detecting unit. A reflection-type diffraction grating element may be used for mirror 103. The reflection type diffraction grating element replacing mirror 3 performs both a reflecting function and a diffraction grating function. Thus, the beam emitted from LD 101 is reflected toward the optical medium and simultaneously divided into a plurality of beams.

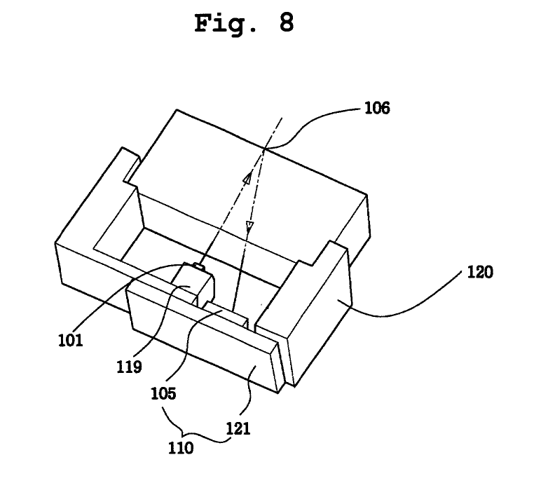

As shown in FIG. 8, mirror 103 and diffraction grating element 102 are eliminated from lead frame package 120. The optical pickup device includes a lead frame package 120 and a detecting unit 110. The lead frame package 120 including sub-mount 119, LD 101 mounted on sub-mount 119, and HOE 106. The detecting unit 110 is disposed to move or rotate about lead frame package 120 and fixed to lead frame package 120. The beam emitted from LD 101 is incident to optical medium 32 through HOE 106. The beam reflected from optical medium 32 is impinged on a photo diode of PDIC 105 of detecting unit 110.

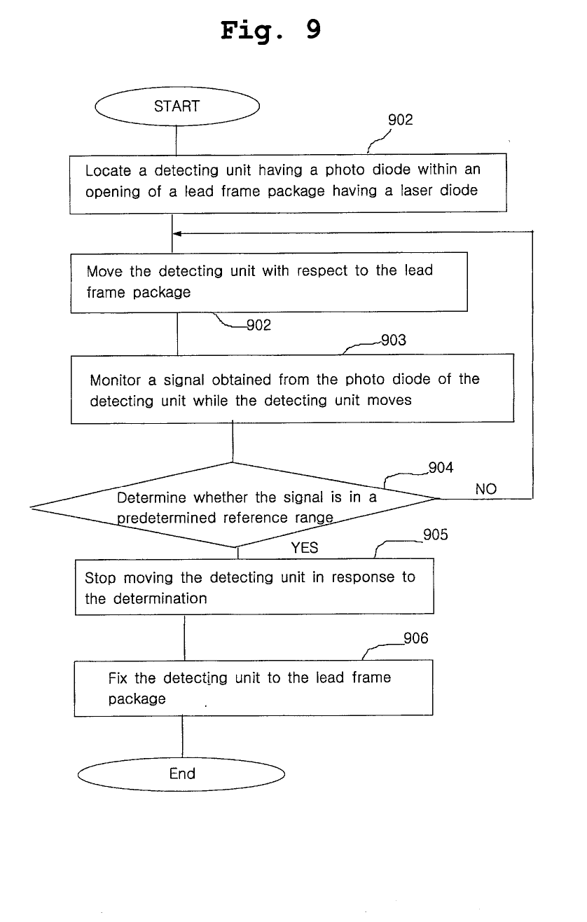

In FIG. 9, a process for assembling detecting unit 110 and lead frame package 120 is described. Detecting unit 110 is located within said opening of said lead frame package in step 901. PDIC 105 connected to an external equipment is moved in step 902 to detect a signal generated from PDIC 105 in step 903. A determination is made whether the signal is in a reference in step 904. Detecting unit 110 is moved with respect to lead frame package 120 until the signal obtained from the photo diode of PDIC 105 of detecting unit 110 is in the reference. Detecting unit 110 is stopped moving in response to the determination in step 905. Detecting unit 110 is fixed to lead frame package 120 in step 906.

As described above, since the relative position between a laser diode of a lead frame package and a photo diode of a detecting unit is precisely adjusted by using and monitoring the beam being incident to the photo diode and by moving the detecting unit in a predetermined direction with respect to the lead frame package during the assembling process, the performance of the optical pickup device is improved, and the assembling process becomes precise and simple.

The number of components for assembling the optical pickup device decreases. Moreover, manufacturing cost is reduced because the PD is formed in respective separate and independent substrate. Compared to the conventional optical pickup device having the LD and the PD mounted on a single substrate with die-bonding, the expensive equipment for die-bonding of the LD and the PD in a single substrate is not needed.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An optical pickup device, comprising;
a lead frame package having a sub-mount, a laser source mounted on said sub-mount and emitting a laser beam, a reflective element reflecting said beam, a transmission-type refraction grating dividing said beam into a plurality of beams including a main beam and two sub beams which are incident to an optical medium, and a hologram optical element diffracting the beams reflected from an optical medium, said lead frame package having an opening communicating with an outside of said lead frame package; and
a detecting unit having a substrate and a photo detector mounted on said substrate, said detecting unit being separate from said lead frame package.

2. The device of claim 1, said detecting unit disposed within said opening of said lead frame package, said detecting unit fixed to said lead frame package after moving to a position to receive said beams diffracted from said hologram optical element.

3. The device of claim 1, said detecting unit being a chip-on-board photo diode package.

4. The device of claim 1, said detecting unit being a flip-chip package.

5. The device of claim 1, said reflective element being a mirror.

6. An optical pickup device, comprising:
a lead frame package having a sub-mount, a light source mounted on said sub-mount and emitting a laser beam, a transmission-type diffraction grating element dividing said beam into a main and two sub beams which are incident to an optical medium, and a hologram optical element diffracting said beams reflected from said optical medium, said lead frame package having an opening communicating with an outside of said lead frame package; and
a detecting unit having a substrate and a photo detector mounted on said substrate, said detecting unit being separate from said lead frame package.

7. The device of claim 6, said detecting unit disposed within said opening of said lead frame package, said detecting unit fixed to said lead frame package after moving to a position within said opening to receive said beams diffracted from said hologram optical element.

8. The device of claim 6, said detecting unit being a chip-on-board photo diode package.

9. The device of claim 6, said detecting unit being a flip-chip package.

10. An optical pickup device, comprising:
a lead frame package having a sub-mount, a light source mounted on a sub-mount and emitting a laser beam, a reflecting element directing said beam onto an optical medium, and a hologram optical element diffracting said beam reflected from said optical medium, said lead frame package having an opening communicating with an outside of said lead frame package; and
a detecting unit having a substrate and a photo detector mounted on said substrate, said detecting unit being separate from said lead frame package.

11. The device of claim 10, said detecting unit disposed within said opening of said lead frame package, said detecting unit fixed to said lead frame package after moving to a position within said opening to receive said beams diffracted from said hologram optical element.

12. The device of claim 10, said reflective element being a reflection-type diffraction grating element dividing said beam emitted from said light source into a plurality of beams including main and two sub beams reflected toward said optical medium.

13. The device of claim 10, said detecting unit being a chip-on-board photo diode package.

14. The device of claim 10, said detecting unit being a flip-chip package.

15. The device of claim 10, said reflective element being a mirror.

16. An optical pickup device, comprising:
a lead frame package having a sub-mount, a light source mounted on said sub-mount and emitting a laser beam which is incident to and reflected from an optical medium, and a hologram optical element diffracting said beams reflected from said optical medium, said lead frame package having an opening communicating with both said hologram optical element and an outside of said lead frame package; and
a detecting unit having a substrate and a photo detector mounted on said substrate, said detecting unit being separate from said lead frame package.

17. The device of claim 16, said detecting unit disposed within said opening of said lead frame package, said detecting unit fixed to said lead frame package after moving to a position within said opening to receive said beams diffracted from said hologram optical element.

18. The device of claim 16, said detecting unit being a chip-on-board photo diode package.

19. The device of claim 16, said detecting unit being a flip-chip package.

20. The device of claim 16, said detecting unit moving in a direction parallel or vertical to said lead frame package and rotating about said hologram optical element before fixed to said lead frame package.

21. A process in an optical pickup device, comprising the steps of:
providing a lead frame package having a sub-mount, a light source mounted said sub-mount and emitting a laser beam which is incident to and reflected from an optical medium, and a hologram optical element diffracting said beams reflected from said optical medium, said lead frame package having an opening communicating with both said hologram optical element and an outside of said lead frame package;
providing a detecting unit having a substrate and a photo detector mounted on said substrate, said detecting unit being separate from said lead frame package;
locating said detecting unit within said opening of said lead frame package;
moving said detecting unit with respect to said lead frame package; and
fixing said detecting unit to said lead frame package.

22. the process of claim 21, further comprising the steps of:
monitoring a signal obtaining said photo detector during movement of said detecting unit with respect to said lead frame package; and
fixing said detecting unit to said lead frame package when said signal is in a predetermined range.
